(19) United States
(12) Patent Application Publication
(10) Pub. No.: US 2021/0030017 A1
(43) Pub. Date: Feb. 4, 2021

(54) WEARABLE CANDY WITH BUILDING TOY ATTACHMENTS

(71) Applicant: Elliott Hartman Albrecht Beaber, Washington, DC (US)

(72) Inventor: Elliott Hartman Albrecht Beaber, Washington, DC (US)

(21) Appl. No.: 16/526,459

(22) Filed: Jul. 30, 2019

(51) Int. Cl. A23G 3/56

(52) U.S. Cl. CPC A23G 3/563

(57) ABSTRACT

Aspects described herein provide a novel wearable candy device that is configured to support a candy and/or other confectionery product. The wearable candy device includes one or more building toy attachment points, some of which may be covered by the candy. After the consumer eats the candy, the attachment points may be exposed and the consumer is left with a wearable device that they can attach building toy figurines and blocks to. Thus, the consumer gets to enjoy the candy but also gets to later enjoy a wearable platform for use in playing with building toys.

### FIELD OF USE

Aspects of the disclosure relate generally to confectionery products and toys. More specifically, aspects of the disclosure may provide a wearable candy device that may be used as a platform for building toys once the candy or other confectionery is consumed.

### BACKGROUND

Many types of candy and other confectionery products exist to delight children and adults alike. From gumdrops to peppermints, from chocolates to cotton candy, from lollipops to popsicles, choices abound. With such a range to choose from, candy makers appreciate that the packaging and presentation of a confectionery product can serve to help consumers pick one product over another. Packaging and presentation can be a driving factor in a consumer's selection of a confectionery product. A simple lollipop—a hard candy on a stick handle—may be too uninteresting to capture the attention of a child in a candy store. As a result, candy makers have looked for creative ways to present their candy and make it more interesting to consumers. For example, the RING POP candy ring provides a plastic jewelry ring that a child can wear while enjoying the hard candy “gem” on the ring's platform. The design of the RING POP candy ring was patented in U.S. Design Pats. 242,645 and 242,646.

But alas, the sweet indulgence of candy is typically fleeting. Once the confectionery product is consumed, the packaging and other pieces such as handles are often tossed away. A candy ring such as the RING POP is typically only worn while the hard candy attached to it is being eaten. Once the candy is gone, the bare platform has limited use other than a ring shaped piece plastic that has lost its gem. Its purpose served, the ring is destined for the trash.

Another class of products that is enjoyed by both children and adults is building toys. Toy building systems, such as LEGO blocks or MEGA BLOKS, may allow users to build structures and scenes by attaching pieces together using attachment points. For example, both referenced building systems use blocks that have protruding studs as attachment points on the top portion of the blocks and recessed receptacles as attachment points on the bottom. Two pieces can be joined by stacking the blocks such that the protruding studs frictionally engage with the recessed receptacles to hold the pieces together. Such building systems typically offer a wide range of building pieces, in many different shapes and configurations. They also may include figurines other than building blocks, facilitating creative play and allowing for the creation of scenes. But building blocks and figurines are usually played with on the ground or other surface, and may not be good for on-the-go play.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may address the fleeting joy of the candy ring by integrating a platform for playing with building toys. A novel wearable candy device is provided that is configured to support a candy and/or other confectionery product. The wearable candy device includes one or more building toy attachment points, some of which may be covered by the candy or other confectionery product. After the consumer eats the candy, the attachment points may be exposed and the consumer is left with a wearable device that they can attach building toy figurines and blocks to. As a result, the consumer gets to enjoy the candy but also gets to later enjoy a wearable platform for use in playing with building toys.

Thus, according to some aspects a wearable candy device is provided that comprises a ring configured to be worn on a finger and a support platform attached to the ring. The wearable candy device may include a confectionery product, e.g. mounted thereon. Many types of confectionery may be suitable for mounting on the wearable candy device, such as hard candy, frozen confectioneries, and others. The wearable candy device may include a first protrusion adapted to support the confectionery product. The first protrusion may be located on a top portion of the support platform and may be centrally located on the top portion of the support platform. The first protrusion may comprise a primary building toy attachment point located at a top end of the first protrusion. The wearable candy device may also include one or more auxiliary building toy attachment points, which may be comprised in one or more second protrusions. The auxiliary building attachment points may be located on the top portion of the support platform and may be located circumferentially on the top portion of the support platform. Each building toy attachment point may comprise one or more protruding studs adapted to frictionally engage with a recessed receptacle of a building toy.

The shape of the first protrusion may be adapted to support mounting the confectionery product. For example, in some embodiments the first protrusion may be wider at its top end than at a mid-point along the length of the first protrusion. The primary building toy attachment point may be located within the confectionery product when the confectionery product is mounted on the first protrusion. The confectionery product may prevent access to the primary building toy attachment point until the confectionery product is consumed. Similarly, the confectionery product may prevent access to the auxiliary building toy attachment points until at least a portion of the confectionery product is consumed.

Different configurations of building toy attachment points may be employed. For example, the primary building toy attachment point may comprise a single protruding stud. But the auxiliary building toy attachment points may comprise, for example, one attachment point that is a 2×2 arrangement of four protruding studs and another attachment point that is a 2×1 arrangement of two protruding studs.

Although aspects of the disclosure are illustrated as a ring configured to be worn on a user's finger, the wearable candy device may be implemented as many other types of accessory articles configured to be worn on a user's body, such as a bracelet, necklace, earring, nose ring, watch, and the like, without departing from the spirit of the disclosure. With each accessory device, a support platform may be attached to the accessory device (ring, bracelet, necklace, etc.) having the features described herein. This may allow users to engage in the type of on-the-go play described herein regardless of their preferred form of accessory.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example wearable candy device, according to some aspects;

FIG. 2 depicts a side view of an example wearable candy device, according to some aspects;

FIG. 3 depicts a top view of an example wearable candy device, according to some aspects;

FIG. 4 depicts an example configuration of an example wearable candy device having a confectionery product mounted thereon, according to some aspects;

FIG. 5 depicts an example configuration of an example wearable candy device having a building toy figurine mounted thereon, according to some aspects; and

FIG. 6 depicts a second example arrangement of building toy attachment points on a wearable candy device, according to some aspects.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

As described above, there is a need for wearable candy devices that continue to provide enjoyment even after the candy has been eaten. Aspects described herein provide a novel wearable candy device that incorporates building toy attachment points into a support platform of the wearable candy device. A consumer may eat the candy (or other confectionery product) to reveal one or more of the building toy attachment points. In particular, a protrusion may be centrally located on the support platform of the wearable candy device and may be adapted to support mounting of the candy thereon. A top end of the central protrusion may comprise a building toy attachment point. Other building toy attachment points may be included on the support platform as well. The confectionery product may prevent access to the building toy attachment points until the user consumes the confectionery product. However, once the confectionery is consumed the user can still enjoy the device which now serves as a wearable building platform.

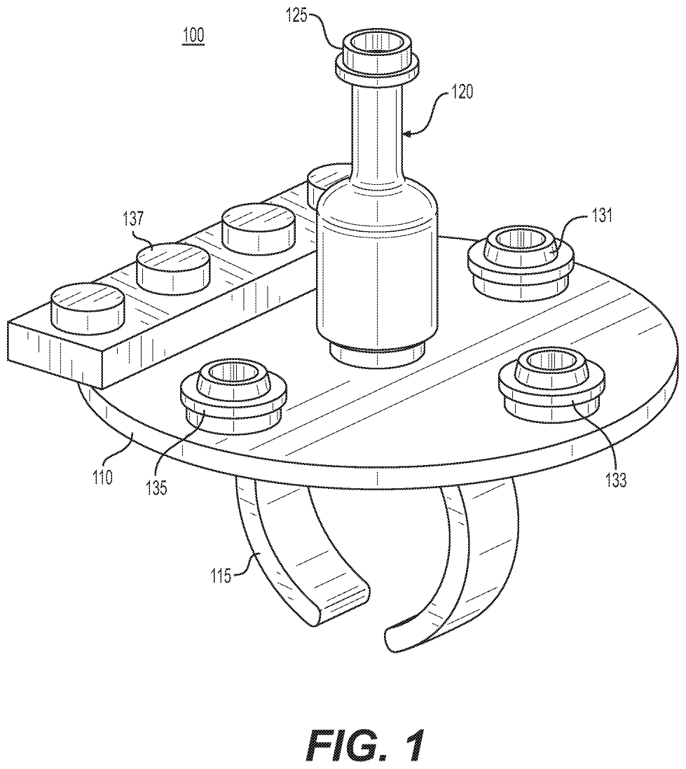

FIG. 1 illustrates an example wearable candy device 100, according to some aspects. Wearable candy device 100 may comprise a support platform 110 and a ring 115. Ring 115 may be configured to be worn on a user's finger. Additionally and/or alternatively, ring 115 may be adapted for wearing on other parts of the user's body, such as in the form of a bracelet for wearing on the user's forearm or wrist. Ring 115 may more generally take the form of any suitable accessory article configured to be worn on a user's body, such as a bracelet, necklace, earring, nose ring, watch, and the like. In the illustrated embodiment of FIG. 1, the wearable candy device comprises a ring configured to be worn on a finger. But the wearable candy device may be implemented as any suitable accessory article configured to be worn on a user's body. Although the discussion herein is with respect to a ring form, aspects of the disclosure apply equally to other accessory device forms.

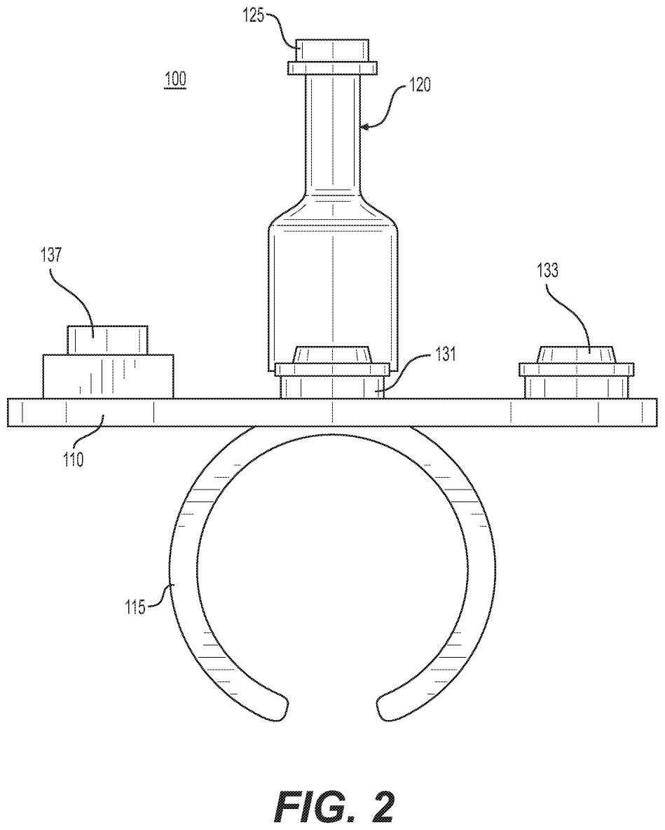

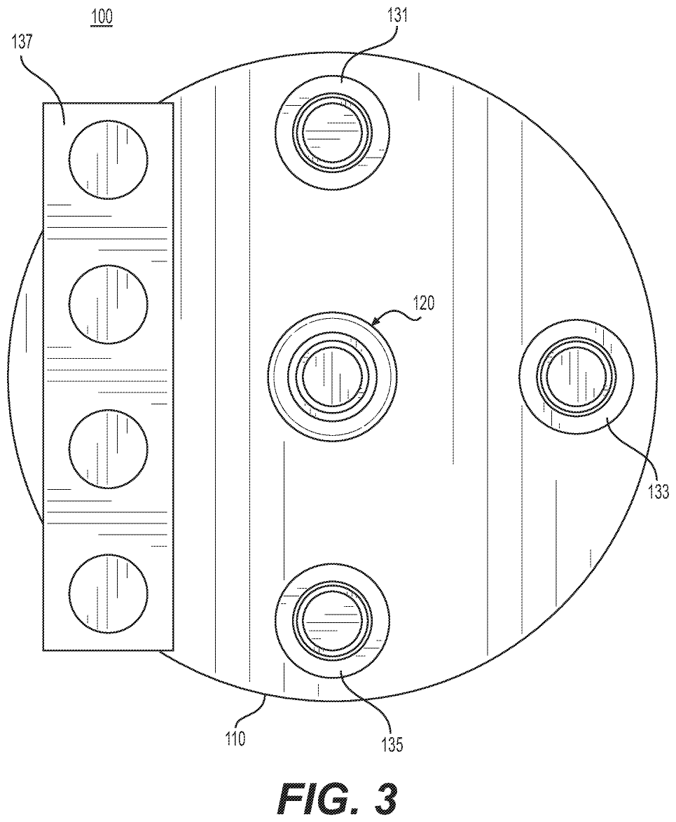

Support platform 110 may be attached to ring 115, and may serve as a platform for various protrusions that comprise building toy attachment points. Support platform 110 and ring 115 are preferably made out of plastic, though any suitable material may be used. To further assist in understanding the example wearable candy device 100, FIG. 2 illustrates a side view of wearable candy device 100 and FIG. 3 illustrates a top-down view of wearable candy device 100. The illustrated elements are the same, as indicated by like reference numbers.

Further illustrated as part of wearable candy device 100 is central protrusion 120 (also referred to as a first protrusion). Central protrusion 120 may comprise a primary building toy attachment point 125 at its top end, away from the support platform. Central protrusion 120 may be attached to the top side of support platform 110, and may be centrally located on the top surface of support platform 110.

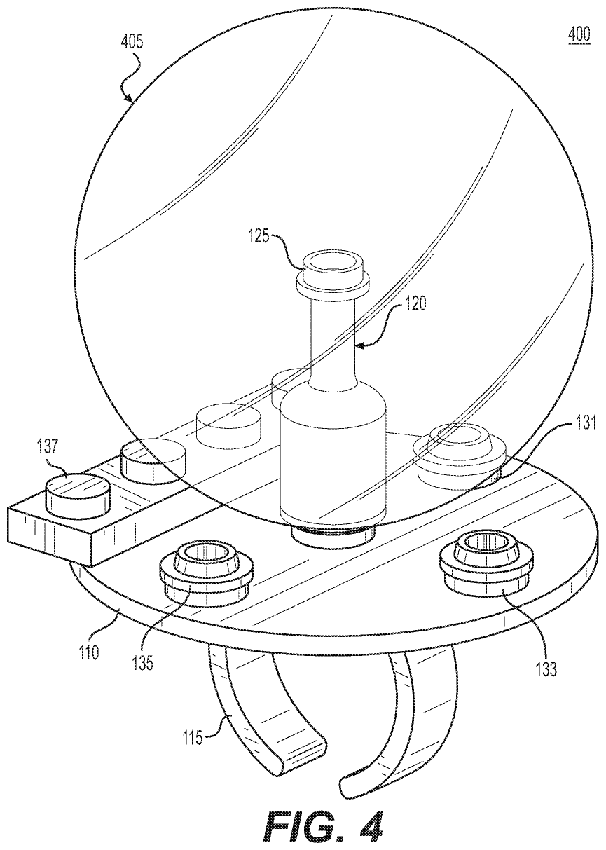

Central protrusion 120 may be adapted to support mounting the confectionery product on central protrusion 120. According to some aspects, a shape of central protrusion 120 may be adapted to hold the hard candy or other confectionery product that makes up part of the wearable candy device. For example, a top end of central protrusion 120 may be wider than a lower point along central protrusion 120, such as at the mid-point of central protrusion 120. This shape may allow, for example, liquid hard candy to be poured around central protrusion 120 such that once the candy hardens it will stay attached to the wearable candy device. Other suitable shapes and features that allow central protrusion 120 to engage with the confectionery product such that it remains attached to the wearable candy device are also within the scope of the disclosure. For example, central protrusion 120 could hold the candy on the wearable candy device through another portion below the top end that is wider than at other portions of central protrusion 120. As another example, grooves in central protrusion 120 may be adapted to provide purchase for the confectionery product, such that it remains attached to the wearable candy device. Details of the confectionery product are discussed further below with respect to FIG. 4.

Primary building toy attachment point 125 may comprise a protruding stud adapted to frictionally engage with a recessed receptacle of a building toy. For example, many building toy systems utilize studs and recessed receptacles (voids) to allow pieces to be attached together. The studs are wide enough to engage with the sides of the receptacle, and friction between the pieces is enough to hold the pieces together. Primary building toy attachment point 125 may be adapted for any particular building toy system, such as LEGO blocks and/or MEGA BLOKS. Users may attach building toys to the wearable candy ring by connecting the recessed receptacles (generally on the bottom of a building toy block or figurine) to the protruding stud of the primary building toy attachment point 125 and/or other building toy attachment points. Thus, to the user the wearable candy ring can transform into a wearable building toy ring.

Although the central protrusion 120 of FIG. 1 is described as centrally located, it should be understood that other arrangements are possible without departing from the spirit of the disclosure. For example, two protrusions located around the center may come together in the center to support the confectionery product. As another example, the protrusion that supports the confectionery product may be offset in some manner as a matter of design.

Wearable candy device 100 also is illustrated as including four auxiliary building toy attachment points 131, 133, 135, and 137. Auxiliary building toy attachment points 131, 133, 135, and 137 may comprise second protrusions attached to the top of support platform 110 but may be located around the circumference of support platform 110. Although illustrated as circumferentially placed on the top of support platform 110, the auxiliary building attachment points may be placed in any suitable location on support platform 110, such as closer-in to the central protrusion 120. Each building toy attachment point may comprise protruding studs for attaching to building toys in a variety of configurations. For example, auxiliary building toy attachment points 131, 133, and 135 each are illustrated as having a single protruding stud adapted for frictionally engaging with a recessed receptacle of a building toy block and/or figurine. But auxiliary building toy attachment point 137 is illustrated as having a 4×1 arrangement of four protruding studs in a line. Any suitable building toy attachment point configuration may be used for any of the auxiliary building toy attachment points.

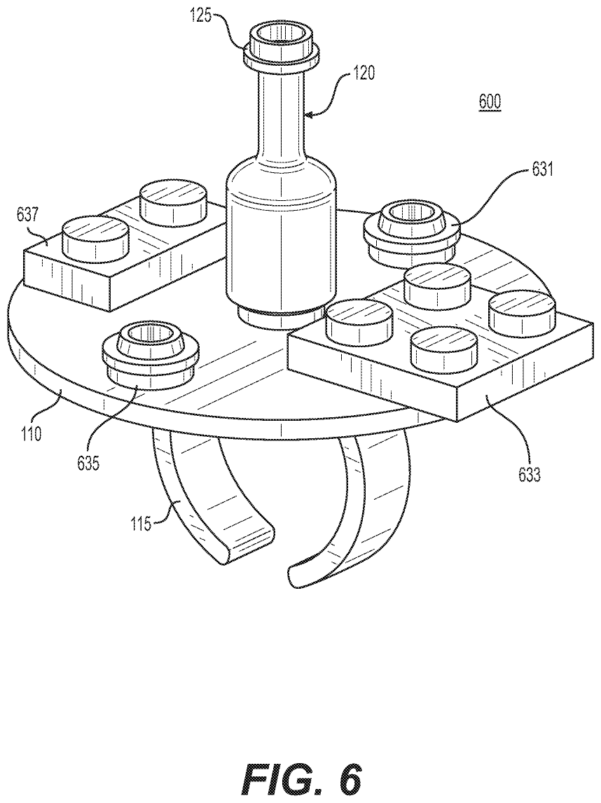

FIG. 6 provides an example of a second configuration of a wearable candy device 600, which has a different set of auxiliary building toy attachment points relative to wearable candy device 100 of FIG. 1. Auxiliary building toy attachment points 631 and 635 may comprise single studs, while auxiliary building toy attachment point 633 comprises four studs in a 2×2 arrangement and auxiliary building toy attachment point 637 comprises two studs in a 2×1 arrangement.

As used herein, “primary” building toy attachment points and “auxiliary” building toy attachment points are labels referring to whether the building toy attachment point is part of a protrusion configured to support the confectionery product (the “primary” building toy attachment points) or part of another protrusion on the support platform (the “auxiliary” building toy attachment points).

Although in some embodiments the auxiliary attachment points may be implemented as secondary protrusions, in some embodiments the auxiliary attachment points may be bodily incorporated in support platform 110, such as through recessed areas on support platform that include protruding studs. In some implementations, the entire surface of support platform 110 may be adapted to serve as a building toy attachment point, covering the surface with protruding studs to give the user a more flexible building platform. In some embodiments, auxiliary building toy attachment points 131, 133, 135, and 137 (FIG. 1) may be omitted entirely and central protrusion 120 may offer the sole building toy attachment point.

FIG. 4 illustrates an example configuration of the wearable candy device 400, which may correspond to wearable candy device 100 of FIGS. 1-3 but has mounted thereon a confectionery product 405. Like reference numerals in FIG. 4 correspond to those described above with respect to FIGS. 1-3.

Confectionery product 405 may be mounted on central protrusion 120. Many types of confectionery products are considered within the scope of the disclosure, though a hard candy may be the most common. Confectionery product 405 may be an edible confectionery product, such as a hard candy, a frozen confectionery such as a popsicle, a chocolate candy, cotton candy, a gummy candy, and the like. As described above, central protrusion 120 may have a shape or other features adapted to support mounting of the confectionery product. Each type of confectionery product may be poured, molded, or otherwise made to attach to central protrusion 120 such that the confectionery product 405 is attached to wearable candy device 400.

In practice, while confectionery product 405 is mounted on wearable candy device 400, the ring 115 and support platform 110 may serve as a handle for the confectionery product 405 while the user eats it. The user may wear ring 115 on their finger and enjoy the candy or other confectionery product. As the confectionery product 405 is consumed, the building toy attachment points may become available to the user. The auxiliary building toy attachment points 131, 133, 135, and 137 may be accessible after the user has partially consumed the candy. The primary building toy attachment point, part of the central protrusion 120, may be accessible only after the user has consumed all of the candy (or at least the portion mounted on and around the primary building toy attachment point).

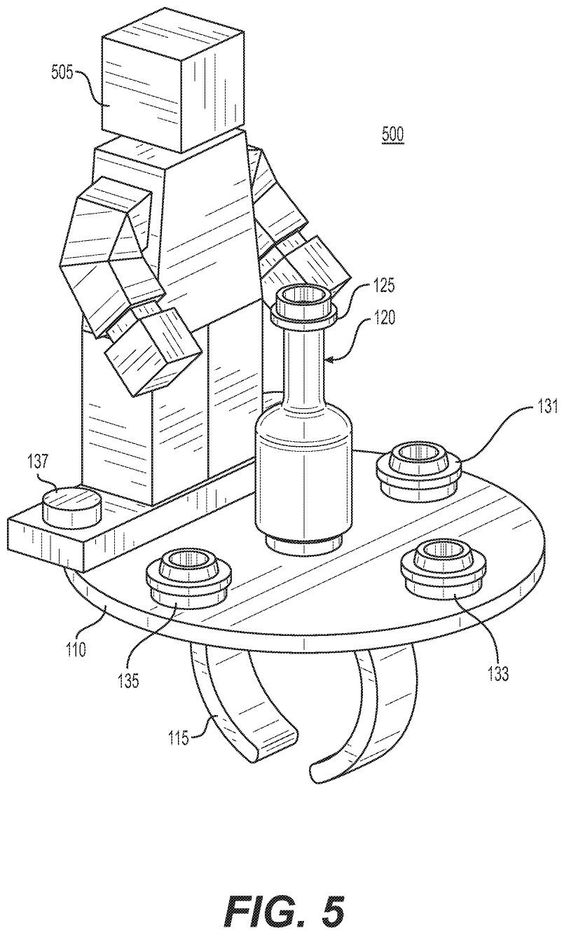

FIG. 5 illustrates an example configuration of wearable candy device 500, which may correspond to wearable candy device 400 after the confectionery product 405 is consumed and the user begins play with building toys. As illustrated in FIG. 5, primary building toy attachment point 125 as well as the auxiliary building toy attachment points 131, 133, 135, and 137 are no longer blocked by confectionery product 405 as they were in FIG. 4. The user is now able to add a building toy figurine 505 by attaching it to building toy attachment point 137. The user may wear wearable candy device 500 and take the building toy figurine 505 with them for on-the-go play. It will be appreciated that several building toy figurines may be attached to wearable candy device 500, and that other building toy blocks may be attached as well.

Some aspects described herein may provide benefits by extending a user's enjoyment of a wearable candy device. In a first stage, the user can enjoy the candy or other confectionery on the wearable candy device. After the candy is consumed, the user can still enjoy playing with the wearable candy device as building toy attachment points are revealed. The wearable candy device, now transformed into a wearable building toy platform, allows for novel on-the-go play with building toys.

Although the subject matter has been described in language specific to structural features and/or methodological acts, it is to be understood that the subject matter defined in the appended claims is not necessarily limited to the specific features or acts described above.

Rather, the specific features and acts described above are disclosed as example forms of implementing the claims.

1. A wearable candy device comprising:
an accessory article configured to be worn on a body of a user;
a support platform attached to the accessory article;
a first protrusion located on a top portion of the support platform and centrally located on the top portion of the support platform, wherein the first protrusion supports a confectionery product mounted thereon and comprises a primary building toy attachment point located at a top end of the first protrusion and within the confectionery product; and
one or more auxiliary building toy attachment points located on the top portion of the support platform and located circumferentially on the top portion of the support platform,
wherein each building toy attachment point, of the primary building toy attachment point and the one or more auxiliary building toy attachment points, comprises one or more protruding studs having a shape adapted to frictionally engage with a recessed receptacle of a building toy.

2. (canceled)

3. The wearable candy device of claim 1, wherein the accessory article comprises a ring configured to be worn on a finger of the user.

4. (canceled)

5. (canceled)

6. The wearable candy device of claim 1, wherein the first protrusion is wider at the top end than at a mid-point along a length of the first protrusion.

7. (canceled)

8. (canceled)

9. The wearable candy device of claim 1, wherein a first auxiliary building toy attachment point of the one or more auxiliary building toy attachment points has a different building toy attachment point configuration relative to a second auxiliary building toy attachment point of the one or more auxiliary building toy attachment points.

10. The wearable candy device of claim 9, wherein:
the first auxiliary building toy attachment point comprises two protruding studs in a 2×1 configuration; and
the second auxiliary building toy attachment point comprises 4 protruding studs in a 2×2 configuration.

11. The wearable candy device of claim 1, wherein the confectionery product prevents access to the primary building toy attachment point until the confectionery product is consumed.

12. The wearable candy device of claim 1, wherein the confectionery product prevents access to the one or more auxiliary building toy attachment points until the confectionery product is at least partially consumed.

13. The wearable candy device of claim 1, wherein the confectionery product comprises a hard candy.

14. The wearable candy device of claim 1, wherein the confectionery product comprises a frozen confectionery.

15. A wearable candy device comprising:
a ring configured to be worn on a finger;
a support platform attached to the ring;
a first protrusion located on a top portion of the support platform, wherein the first protrusion supports a confectionery product mounted thereon and comprises a primary building toy attachment point located at a top end of the first protrusion and within the confectionery product;
one or more auxiliary building toy attachment points located on the support platform; and
the confectionery product, mounted on the first protrusion, wherein the primary building toy attachment point is located within the confectionery product on the first protrusion and wherein the confectionery product prevents access to the primary building toy attachment point until the confectionery product is consumed
wherein each building toy attachment point, of the primary building toy attachment point and the one or more auxiliary building toy attachment points, comprises one or more protruding studs adapted to frictionally engage with a recessed receptacle of a building toy.

16. (canceled)

17. The wearable candy device of claim 15, wherein the first protrusion is wider at the top end than at a mid-point along a length of the first protrusion.

18. The wearable candy device of claim 15, wherein the confectionery product prevents access to the one or more auxiliary building toy attachment points until the confectionery product is at least partially consumed.

19. The wearable candy device of claim 15, wherein the confectionery product comprises a hard candy.

20. A wearable candy device comprising:
an accessory article configured to be worn on a body of a user;
a support platform attached to the accessory article;
A first protrusion located on a top portion of the support platform and centrally located on the top portion of the support platform, wherein the first protrusion supports a confectionery product mounted thereon and comprises a primary building toy attachment point located at a top end of the first protrusion;
one or more auxiliary building toy attachment points located on the support platform; and
the confectionery product, mounted on the first protrusion, wherein the primary building toy attachment point is located within the confectionery product on the first protrusion and wherein the confectionery product prevents access to the primary building toy attachment point until the confectionery product is consumed,
wherein each building toy attachment point, of the primary building toy attachment point and the one or more auxiliary building toy attachment points, comprises one or more protruding studs having a shape adapted to frictionally engage with a recessed receptacle of a building toy.

21. The wearable candy device of claim 20, wherein the first protrusion is wider at the top end than at a mid-point along a length of the first protrusion.

22. The wearable candy device of claim 20, wherein the confectionery product comprises a hard candy.

23. The wearable candy device of claim 20, wherein the confectionery product comprises a frozen confectionery.
